(19) United States
(12) Patent Application Publication
(10) Pub. No.: US 2014/0297517 A1
(43) Pub. Date: Oct. 2, 2014

(54) MOBILE CHECK BOOK

(71) Applicant: EBAY INC., San Jose, CA (US)

(72) Inventor: Venkatesh Gnanasekaran, San Jose, CA (US)

(73) Assignee: EBAY INC., San Jose, CA (US)

(21) Appl. No.: 13/852,207

(22) Filed: Mar. 28, 2013

(51) Int. Cl. G06Q 20/04

(52) U.S. Cl. CPC G06Q 20/0425
USPC 705/39

(57) ABSTRACT

A service provider permits a user to set a digital check account for having digital checks issued therefrom and generated on the user device. The digital check bears a routing number, an account number, an account holder's name, a check amount, a signature of the user, and a payee's name. The digital check may be generated by a local user application on the user device via check information entered by the user and account information either saved locally in the user device or transmitted real time by the service provider. The digital check may be generated on the user device via a full interactive process after the service provider receives a digital check issuance request with a payee identifier and the check amount. The digital check may be issued from either the service provider's own account or an external account(s) the user has with a third party.

### BACKGROUND

1. Field of the Invention

The present invention generally relates to a field of handling finances in a commercial transaction, particularly to a system and method of payment.

2. Related Art

In a credit-based society nowadays, more and more commercial transactions, even in the area of small daily economic activities of the public, are being conducted without using any cash, aiming for a totally cashless society. Various kinds of non-cash payment means have come to infiltrate virtually every area in commercial transactions. Even though magnetic based payment means such as credit cards, debit cards, store-charge cards, or cyber money dominate among a variety of non-cash means used today, still, personal checks are being widely used across the board as a payment means for: commercial purchases, whether online or offline; rent, utilities, and various hyper-local bills; donations; or other purposes. In fact, it is reported that every year, Americans are still writing about 11 billion checks.

Handling and using physical, hard copy of checks, however, is sometimes cumbersome and inconvenient, not only to the writers of the checks, but also to those who accept the checks for payment or to the financial institutions that issue or take them for processing. Physical checkbooks are usually too bulky to carry in a wallet or purse, and being made of paper, vulnerable to tearing, soaking, tainting, or kinds of physical damage. In many places, a writing instrument that is needed to write a check with may not be available. Also, for a physical check, any error in putting a payee's name, check amount, date, or signature cannot be readily corrected other than by crossing out the erroneous line with a pen, which would make the check look untidy, or by destroying the entire check in error and rewriting a new one. Further, a physical check is accompanied by a risk of theft or loss, and a potential misappropriation with a forged signature by some wrongful acquirer of it. All these inconveniences are carried to the merchants or any other recipients of checks as well until the checks are deposited with suitable financial institutions, which themselves would suffer the hassle of having to handle, process, and keep for record thousands or tens of thousands of physical checks flooding in on a daily basis. The considerable amount of paper consumed every year for issuing physical checks also cannot be neglected, and especially in the current era of paperless society, may be considered even a waste.

Recently, a number of service providers or payment providers, such as PayPal, Inc. of San Jose, Calif., that allow the everyday commercial transaction easier and more convenient have emerged and been growing up rapidly. Various business schemes have been developed by such payment providers to facilitate transactions between merchants and consumers, particularly payment transactions. For example, many services provided by these service or payment providers aim at facilitating payment using credit cards or cyber funds with the use of users' mobile phones or other similar portable devices equipped with a breadth of functionality commensurate with almost an old days' mini-computer and suitable applications.

Since personal or business checks are still widely used for various reasons in almost every area of commercial transactions despite the prevalent use of credit cards and the like, and because of a number of inconveniences and disadvantages involved with using physical paper checks as noted before, it would be desirable if a business scheme can be provided that facilitates use of checks, in a paperless form, under a secure transaction environment in making payments in commercial transactions for more ease and convenience, possibly, with an aid of a service or payment provider enabling paperless checks and/or a mobile phone or similar devices.

### BRIEF DESCRIPTION OF THE FIGURES

FIG. 1 is a flowchart showing a process a service provider performs in permitting a user to set up a digital check account for having a digital check issued from the account and generated by the user on a user device, according to one embodiment of the present disclosure;

FIG. 2 is a flowchart showing a process a service provider performs in receiving and processing a digital check issuance request from a user and issuing a digital check on the user device, according to one embodiment of the present disclosure;

FIG. 3 is block diagram of a networked system suitable for implementing the processes described herein according to an embodiment of the present disclosure; and

FIG. 4 is a block diagram of a computer system suitable for implementing one or more components in FIGS. 2 and 3 according to one embodiment of the present disclosure.

### DETAILED DESCRIPTION

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

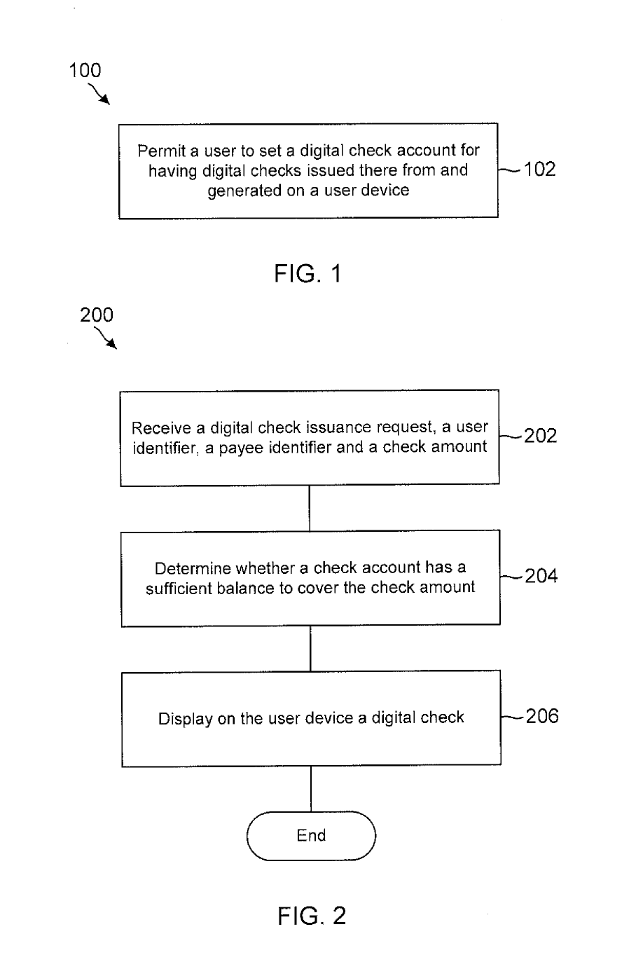

FIG. 1 is a flowchart showing a process 100 a service provider performs in permitting a user to set up a digital check account for having a digital check issued from the account and generated by the user on a user device. The service provider is any payment provider such as PayPal, Inc. of San Jose, Calif., or financial institution who provides the service of permitting use of a digital check by a user who has an account with the service provider. The user may be a customer/buyer who wishes to pay to a vendor or merchant with a personal or business check for any products or services purchased or received therefrom. But the user may be any person who has an account with the service provider, who needs a digital check issued from the account for whatever purposes to pay to whoever is willing to accept the digital, instead of a physical or paper, check.

Now referring to FIG. 1, at step 102, the service provider permits the user to set an account for having a digital check issued therefrom and generated on the user device. The set up process at step 102 is performed by the user via a user application installed on the user device. The user device may be a server, PC, tablet, iPad™, mobile phone or any other suitable device that has a capability of wireless communication with the service provider. The user application may have been developed and provided either directly by the service provider or by a third party, which may be downloaded and installed on the user device, typically, free of charge.

The account the user sets up at step 102 for the purpose of having digital checks issued therefrom (hereinafter, “the digital check account”) may be any personal or business account in nature. In one embodiment, the digital check account may be an account the user has with the service provider, such as an ordinary bank checking account. If there is no such account opened yet, then at the time of setting up the digital check account, the user may be able to newly open an account with the service provider for the purpose of using digital checks therefrom. In another embodiment, the digital check account may be a preexisting account the user has with a third party, such as a bank or credit card company, which becomes associated with the account with the service provider. In an embodiment, the user may set up multiple digital check accounts the user has with either the service provider or a third party, or both. The multiple digital check accounts may include, for example, bank accounts and credit card accounts.

During the initial set up process, the user is able to enter all information on the digital check account. If the digital check account is directly carried by the service provider, the routing number and account number for the digital check account may be automatically assigned by the service provider. But if the digital check account is carried by a third party, such as a checking account of a third party bank, the user may need to enter, during the initial set up, all information on the account and the third party such as the account issuer's name (the third party's name), the routing number, and account number for having that account associated with the account the user has with the service provider (hereinafter “service provider account”) for issuing digital checks therefrom. If the user wishes to associate multiple third party accounts, as digital check accounts, to the service provider account, the user may need to provide account information for each of the multiple accounts during the initial set up. Also, in the case there are multiple digital check accounts, the user may set up a predetermined preferred order of using the multiple digital check accounts as the funding source of a digital check. If there is such an order set up, then when the user generates a digital check on the user device, the digital check will be automatically issued from the most preferred digital check account, according to the order. But the user may be able to change the order, or appoint another digital check account for issuing a particular digital check at the time of generating the digital check on the user device.

Further, during the initial set up process, the user may be able to configure the account and decide on various preferences about the digital check. The user may requested to enter, first, all basic information to be printed on the digital check, such as the name and address of, either the user if it is a personal check, or a business entity if it is a business check. Also, if a user's signature is to be shown on the digital check, the user may register her or his signature with the service provider during the initial set up process by, in an embodiment, directly drawing a signature in a field popped up on the user device by the user application. For that, the user may use either a stylus pen or a finger if the touchscreen is available. The user may try several drawings of the signature until a satisfactory image is obtained before final registration of it. In another embodiment, the user may be allowed to upload and register an image of a pre-drawn signature. Further, the user may be able to determine the designs and overall look of the digital check to be shown on the user's device. For visually assisting the user with determining the design details, an image of a prospective digital check with different tentative, intermediate design choices may be displayed on the user device, with all the basic check information printed thereon. In one embodiment, the user may simply choose her or his preferred design from multiple images of checks designed by the service provider and displayed on the user device. Or in another embodiment, the user may choose only a basic skin, and change the design details such as the size, font, and color of the texts or lines, the color of the background, any marks, symbols, or other design elements to be appearing on the digital check. In still another embodiment, if desired, the user may upload and register a predesigned digital check. Moreover, the user may be allowed to use multiple digital checks of different skins or designs, especially when the user sets up multiple digital check accounts. In this case, the user may repeat the configuration process of design preferences for each different digital check and for each different digital check account.

Once the user finishes setting up a digital check account with the service provider, all the information and preference entered during the set up process may be transmitted to a user application on the user device so that the user may be able to locally generate digital checks on the user device. In one embodiment, the entered account information may be transmitted to the user device immediately at the time of setting up the digital check account, which may remain stored locally in the user device and used when the user subsequently generates a digital check. But in another embodiment, out of security concern that may arise from, for example, loss of the user device, some sensitive account information such as routing number and account number, may be transmitted to the user device only at the time the user performs the process of generating a particular digital check on her or his device. Practically, the digital checks in the present disclosure are replicating a physical check books carried by people in a purse, wallet or bag except for the fact that the digital checks are generated and stored on user's devices, such as mobile phones, in a digital format.

Described herein below is how a digital check can be locally produced on a user device in an embodiment of the present disclosure. From a user device, the user loads the user application for generating a digital check, which may direct the user to a home screen on the user device. On the home screen, the user may be given a choice, via a tab, button, or link, between using a check of a predetermined design or a check chosen from multiple designs if multiple checks of different designed were registered during the initial set up process. If the user clicks on, for example, a button named “use a predetermined design,” a check with all predetermined design elements and check information may be displayed on the device screen. If the user clicks on, for example, a button named “choose from multiple design,” all multiple check images preregistered may be displayed on the screen for the user to choose a desired one by, for example, clicking or tapping on an image or icon.

Further, if the user has previously set up multiple digital check accounts as described herein before, the user may be further given a choice, via a tab, button, or link, between whether to issue the digital check from the most preferred digital check account according to the preset order of using multiple digital check accounts, or whether to choose a particular digital check account for issuing the digital check in subject. Again, by clicking on, for example, an appropriate button or tab, the user can make a choice. If the user wishes to choose one from multiple digital check accounts preregistered, the user may do it by clicking on, for instance, a drop down menu listing all multiple digital check accounts.

Thereafter, the user may be requested to enter the total check amount to be carried by the digital check in a field popped up on the device screen. Using a number keypad on the user device, either shown on the screen or a physical portion of the device, and a suitable input means such as a stylus pen, touch screen, touchpad or mouse, the user may enter the total check amount in the provided field.

Once the total amount of the check is entered, the user may be prompted, by another popped up window, to determine whether the user wishes to enter the payee's name directly, or have it determined by using the location information of the user device. Many user devices used nowadays, such as smart phones, are typically equipped with a global positioning system (GPS) chip or have a standalone GPS connected thereto, which produces GPS data telling the current location of the user devices. The GPS data consist of latitude and longitude coordinates in units of degrees with decimals, which represent each location on the earth from 180° west through 180° east along the Equator and 90° north through 90° south along the prime meridian. Depending on a particular type the GPS chip, the data can also include altitude, bearing, distance, accuracy data, and place names. These days, locations of many large or medium sized offline stores of main merchants in the market are known and on various data bases, typically linked with a map. Therefore, knowledge of a specific location of a merchant's store, via GPS information, may allow a ready identification of the merchant and automatic determination of the payee's name. In one embodiment, such determination of the payee may be locally done by the user application at the user device, aided by a local or network GPS database. In another embodiment, it may be the service provider that determines the payee's name, whereby the service provider receives the GPS data transmitted from the user device and determines the payee's name by using a commercial or its own GPS database. In either embodiment, when the user chooses the option of utilizing GPS information to determine the payee's name by, for example, tapping or clicking on a button, tab, or link for such an option, the user device may immediately generates the GPS data of the present location of the user device.

Once the payee's name is determined from GPS data, either by the service provider or by the user application, in one embodiment, the payee's name may be displayed on the user device for immediate confirmation by the user or the payee on correctness. In another embodiment, the user application may automatically prepopulate the payee's name on the corresponding line on the digital check, which can be changed if in error by the user.

There are a number of situations when the user needs or wants to enter the payee's name directly on the user device. Even when the user chooses the option to let the user application determine the payee's name from the GPS data picked up by the user device, at times the user application may not be able to correctly identify the payee for various reasons. For example, the GPS database used by the user application may be temporarily malfunctioning or failing. In this case, the user application on the user device will prompt the user of such failure and request to enter a payee's name in a field popped up. Or, it can happen that the merchant's name or store's name has recently changed and the GPS database is not updated with the change, thereby returning a wrong payee's name. In these situations, the user still needs to directly give the payee's name to the user application.

Most of other situations when the user has to give the payee's name to the user application occur when the premises the check payment is to be made are not connected with GPS data and thus not identifiable therefrom. For example, the merchant may not enjoy much commercial publicity, or its store may not be large enough to enlist its name in a data base, linked with GPS data of its location(s). The user may readily check with the merchant on whether this is the case. Or, the payee may not be any merchant at all. Or the check payment may be made in some non-commercial premises, such as private houses or outdoor, to eliminate any chance for the place to be on a GPS data base. Another situation when the user may have to directly enter payee's name is when the recipient of the check wishes, for whatever reason, to put a different name, other than the name obtainable from the GPS data, as the name of the payee on the check. In these situations, whether the user chose the option of directly entering the payee's name from the beginning or whether the user was subsequently prompted to enter the payee's name due to the inability of the user application to determine the payee's name, the user may directly enter the payee's name into a field provided by the application, using a suitable entry means such a keypad, touchpad or mouse. The user may also enter a payee name by saying the payee's name into the user device, select a payee from a user contact list on the user device, or select a payee from a list of pre-selected payees.

After the user finishes entering all information needed to issue a digital check, the user application may display a full image of a prospective digital check to be generated on the user device for the user's (and the payee's if necessary) a final review and confirmation of all information on the check. If any information, such as the check amount or the payee's name, is incorrect on the tentative check, the user is given a chance to edit the information by, for example, tapping or clicking on a “edit” button or tab shown on the screen next to the erroneous entry, which will pop up another window in which the user may conduct a necessary editing. In another embodiment, the check information such as the check amount or the payee's name may be shown in, instead of a prospective check image, but a table for instance, in which the user may still be able to edit the information if there is an error.

After making sure that all information on the check is correct, the user may tap or click on, for example, a “confirm” or “transmit” tab or button on the device screen to generate a digital check. Then the user application may display the digital check of the requested amount on the user device for the user to use it for payment. The digital check generated on the user device may have the appearance of an ordinary paper check, bearing typical check infatuation such as a check issuer's name (for example, either the name of the service provider or a third party), a check account holder's name (the user's name if the check is personal check, or the name of a business entity if the check is from a business account), an account number, a check number (serially assigned by the service provider), the check amount, a payee's name (either determined by GPS data or provided from the user), the date of issuance, and the user's signature. A user account number may also be displayed on the check in other embodiments. Alternatively, not all the above information may be required for the digital check. For example, the check issuer's name may not be needed if the check can be processed with other information on the check, such as an account number and a routing number or other check issuer identifier. In one embodiment, the user's signature placed on the digital check may be the one pre-registered with the service provider at the initial set up of the user's account for digital checks. In another embodiment, the user may be requested by the user application to place the signature on a field provided on the user device, by a suitable drawings means such as a stylus pen or even a finger on a touchscreen, at the time of generating each digital check.

The payment by the digital check displayed on the user device may be easily conducted by capturing the image of the digital check by the device of the check recipient. For instance, almost all mobile phones used these days have a digital camera or a scanner, such as Zxing. The image of the digital check can be readily captured by the camera or the scanner of the check recipient and stored therein in a suitable format. If a mobile phone with such functionality is not available, the recipient of the check may use a standalone digital camera or scanner to capture the image of the digital check.

The digital check paid to the payee can be deposited, to be redeemed, to any financial institution that accepts a digital check, including the service provider. For example, the check can be deposited via a wired transfer of the captured image of the digital check from the check recipient's device to a suitable physical portal located at a financial institution. The image of the digital check can be also deposited to a financial institution by a wireless transmission to an online portal if the financial institution is equipped with such a system. Or, if it is preferred, the recipient may print the image of the digital check and make a deposit of it as is done with ordinary paper checks. The digital check deposited into a financial institution can go through the ordinary clearance procedures, just as with paper checks, at the financial institution that carries the particular digital check account from which the particular digital check has been issued.

If a particular digital check is issued from an account the user opened directly with the service provider, not with any external accounts the user has with external financial institutions, then the digital check returns to the service provider for clearance. The service provider may receive the digital check directly from the payee of the digital check or another financial institution with which the payee deposited the digital check. The service provider may determine whether the account of the user has a sufficient balance to cover the check amount. If the balance is sufficient, the check amount is drawn from the user's account with the service provider, reducing its balance.

FIG. 2 is a flowchart showing a process 200 a service provider performs in receiving and processing a digital check issuance request from a user and issuing a digital check on the user device. The service provider is any payment provider such as PayPal, Inc. of San Jose, Calif., or financial institution who provides the service of issuing a digital check to its customer/user (hereinafter “user”) who has an account with the service provider. The user may be a customer/buyer of a merchant who wishes to pay to the merchant with a personal or business check for products or services purchased or received therefrom. But the user may be any person who has an account with the service provider, who needs a digital check issued from the account for whatever purposes to pay to whoever is willing to accept the digital, instead of a physical or paper, check. The user has previously set up with the service provider the account, whether personal or business in nature, for having digital checks issued therefrom, via a user device and a user application installed therein. The user device may be a server, PC, tablet, iPad™, mobile phone or any other suitable device that has a capability of wireless communication with the service provider. The user application installed in the user device enables the user to not only set up an account, but also make a request to the service provider to issue a digital check. The user application may be developed and provided either by the service provider or a third party, which is downloaded and installed on the user device free of charge.

At the time of setting up an account for the digital check, the user may be able to either open a new account for the purpose of using digital checks or connect a preexisting account with the service provider to use it for the same purpose. During the initial set up, the user is able to configure the account and decide on various preferences about the digital check. The user may requested to enter, first, all basic information to be printed on the digital check, such as the name and address of either the user if it is a personal check, or a business entity if it is a business check. Also, if a user's signature is to be shown on the digital check, the user may register her or his signature with the service provider during the initial set up process by, in an embodiment, directly drawing a signature in a field popped up on the user device by the user application. For that, the user may use either a stylus pen or a finger if the touchscreen is available. The user may try several drawings of the signature until a satisfactory image is obtained before final registration of it. In another embodiment, the user may be allowed to upload and register an image of a pre-drawn signature. Further, the user may be able to determine the designs and overall look of the digital check to be shown on the user's device. For visually assisting the user with determining the design details, an image of a prospective digital check with different tentative, intermediate design choices may be displayed on the user device, with all the basic check information printed thereon. In one embodiment, the user may simply choose her or his preferred design from multiple images of checks designed by the service provider and displayed on the user device. Or in another embodiment, the user may choose only a basic skin, and change the design details such as the size, font, and color of the texts or lines, the color of the background, any marks, symbols, or other design elements to be appearing on the digital check. In still another embodiment, if desired, the user may upload and register a predesigned digital check. Moreover, the user may be allowed to register multiple digital checks of different skins or designs, all issuable from the same account. In this case, the user may repeat the configuration process of design preferences for each different digital check.

Now referring to FIG. 1, at step 202, the service provider receives, from the user via the user device, a check issuance request, a user identifier, a payee identifier, and a check amount. Note that this information need not be received at the same time from the user device and certain information may be automatically received by the service provider, such as a user identifier from the device. For that, the user first accesses an account she or he previously set up with the service provider through the user device. The user may access the account using the same user application used to initially set up the account. The user application, developed typically by the service provider or by a third party at the service provider's request, and installed on the user device, allows the user to access the account and conduct a series of tasks in regard with the process 200 for issuing a digital check by the service provider. Accessing the account may include entering any requested user identifier, that is, identification and/or authentication information, such as a user name, email address, phone number, password, PIN, pass code, etc., into one or more fields provided on the screen of the user device via a device keyboard or keypad, or speaking the identifier into a device microphone. Once the user has been authenticated, the user may be directed to a home screen on the user's account.

A request to issue a digital check by the service provider may be initiated by the user by tapping or clicking on a tab, button, or link on the home screen that reads as, for example, “generate a digital check,” through a suitable input means such as a touch screen, touchpad, or mouse of the user device. In one embodiment, the digital check issuance request may be transmitted to, and recognized by, the service provider immediately at the moment of activating such a tab, button, or link. Or in another embodiment, it may be transmitted to, and recognized by, the service provider only at the last stage when, after entering all details of the check such as the check amount and payee's name have been entered, the user confirms, by tapping or clicking on, for example a “confirm” button or tab, at which moment the check details are transmitted to the service provider simultaneously.

Once the user initiates the digital check request process on the user device, a separate window may pop up on the screen to prompt the user to choose a particular design of a digital check if there are multiple checks of different designs previously registered with the service provider during the initial set up process. In that case, the user may choose a desired one by, for example, clicking or tapping on an image or icon, out of the check images displayed in the window.

Thereafter, the user may be requested to enter the total check amount to be carried by the digital check in a field popped up on the screen of the user device. Using a number keypad on the user device, either shown on the screen or a physical portion of the device, and a suitable input means such as a stylus pen, touch screen, touchpad or mouse, the user may enter the total check amount in the provided field in the window.

Once the total amount of the check is entered, the user may be prompted, by another popped up window, to determine whether the user wishes to enter the payee's name directly, or have it determined by using the location information of the user device. Many user devices used nowadays, such as smart phones, are typically equipped with a global positioning system (GPS) chip or have a standalone GPS connected thereto, which produces GPS data telling the current location of the user devices. The GPS data consist of latitude and longitude coordinates in units of degrees with decimals, which represent each location on the earth from 180° west through 180° east along the Equator and 90° north through 90° south along the prime meridian. Depending on a particular type the GPS chip, the data can also include altitude, bearing, distance, accuracy data, and place names. These days, locations of many large or medium sized offline stores of main merchants in the market are known and on various data bases, typically linked with a map. Therefore, knowledge of a specific location of a merchant's store, via GPS information, may allow a ready identification of the merchant and automatic determination of the payee's name. In one embodiment, such determination of the payee may be locally done by the user application at the user device, aided by a local or network GPS database. In another embodiment, it may be the service provider that determines the payee's name, whereby the service provider receives the GPS data transmitted from the user device and determines the payee's name by using a commercial or its own GPS database. In either embodiment, when the user chooses the option of utilizing GPS information to determine the payee's name by, for example, tapping or clicking on a button, tab, or link for such an option, the user device may immediately generates the GPS data of the present location of the user device.

Once the payee's name is determined from GPS data, either by the service provider or by the user application, in one embodiment, the payee's name may be displayed on the user device for immediate confirmation by the user or the payee on correctness. In another embodiment, the user application may automatically prepopulate the payee's name on the corresponding line on the digital check, which can be confirmed or changed if in error any time before transmitting the final confirmation for the issuance of the check. Particularly in an embodiment where the payee's name is determined by the service provider, the identifier of the payee, transmitted to the service provider at step 202, is not the payee's name, but the GPS data of the payee's location. But if it is the user application that determines the payee's name from the GPS data, the identifier of the payee transmitted to the service provider at step 102 will be the payee's name itself.

There are a number of situations when the user needs or wants to enter the payee's name directly on the user device. Even when the user chooses the option to let the service provider determine the payee's name from the GPS data transmitted from the user device, at times the service provider may not be able to correctly identify the payee for various reasons. For example, the GPS database used by the service provider may be temporarily malfunctioning or failing. In this case, the user application on the user device will prompt the user of such failure and request to enter a payee's name in a field popped up. Or, it can happen that the merchant's name or store's name has recently changed and the GPS database is not updated with the change, thereby returning a wrong payee's name. In these situations, the user still needs to directly give the payee's name to the service provider.

Most of other situations when the user has to give the payee's name to the service provider occur when the premises the check payment is to be made are not connected with GPS data and thus not identifiable therefrom. For example, the merchant may not enjoy much commercial publicity, or its store may not be large enough to enlist its name in a data base, linked with GPS data of its location(s). The user may readily check with the merchant on whether this is the case. Or, the payee may not be any merchant at all. Or the check payment may be made in some non-commercial premises, such as private houses or outdoor, to eliminate any chance for the place to be on a GPS data base. Another situation when the user may have to directly enter payee's name is when the recipient of the check wishes, for whatever reason, to put a different name, other than the name obtainable from the GPS data, as the name of the payee on the check. In these situations, whether the user chose the option of directly entering the payee's name from the beginning or whether the user was subsequently prompted to enter the payee's name due to the inability of either the service provider or the user application to determine the payee's name, the user may directly enter the payee's name into a field provided by the application, using a suitable entry means such a keypad, touchpad or mouse. The user may also enter a payee name by saying the payee's name into the user device, select a payee from a user contact list on the user device, or select a payee from a list of pre-selected payees. In these cases as well, the identifier of the payee transmitted to the service provider at step 202 will be the name of the payee itself.

After the user finishes entering all information needed to issue a digital check, but before making a final transmission of the same to the service provider at step 202 by confirming the information, the service provider may display a full image of a prospective digital check to be issued on the user device for the user's (and the payee's if necessary) a final review and confirmation of all information on the check. The prospective digital check displayed, provided for the user's review on check information and not as the final version of the digital check, may have the signature line and/or date line blank, which will be filled by the service provider in the formally issued digital check. If any information, such as the check amount or the payee's name, is incorrect on the tentative check, the user is given a chance to edit the information by, for example, tapping or clicking on a “edit” button or tab shown on the screen next to the erroneous entry, which will pop up another window in which the user may conduct a necessary editing. In another embodiment, the check information such as the check amount or the payee's name may be shown in, instead of a prospective check image, but a table for instance, in which the user may still be able to edit the information if there is an error.

After making sure that all information on the check is correct, the user may transmit the digital check issuance request, the check amount, and the payee's identifier, which the service provider receives at step 202, by tapping or clicking on, for example, a “confirm” or “transmit” tab or button on the device screen. In one embodiment, such transmission of the final confirmation of all check information may constitute the request for digital check issuance. But in another embodiment, the service provider may consider the user's act of initiating the check issuance requesting process, for example, clicking on a “generate a digital check” tab, as such a request. As noted above, the identifier of the payee is, in some embodiments, based on the GPS data of the user device, and in others, the payee's name itself. Further, the service provider has already received the user identifier from the user device when the user accessed the user account and initiated the check issuance requesting process.

Continuing to refer to FIG. 2, at step 204, the service provider determines whether the account of the user or any account associated therewith has a sufficient balance to cover the check amount transmitted to the service provider at step 202. If the balance is sufficient, the service provider may proceed with issuing the requested digital check, but if it is insufficient, the service provider may inform the user on the user device of such insufficiency and allow the user to modify the check amount and resubmit the check issuance request, or cancel the whole process. The user may also be given the option of adding a funding source to cover the check amount.

Still referring to FIG. 2, if the user account has a sufficient balance to cover the requested check amount, then at step 206, the service provider issues and displays the digital check for the requested amount on the user device for the user to use it for payment. The issued digital check displayed on the user device may have the appearance of an ordinary paper check, bearing typical check information such as a check issuer's name (which may or may not be the same as the service provider's name), a check account holder's name (the user's name if the check is personal check, or the name of a business entity if the check is from a business account), a check number (serially assigned by the service provider), the check amount, a payee's name (either determined by GPS data or provided from the user), the date of issuance, and the user's signature. A user account number may also be displayed on the check in other embodiments. Alternatively, not all the above information may be required for the digital check. For example, the check issuer's name may not be needed if the check can be processed with other information on the check, such as an account number or other check issuer identifier. In one embodiment, the user's signature placed on the digital check may be the one pre-registered with the service provider at the initial set up of the user's account for digital checks. In another embodiment, the user may be requested to place the signature, by a suitable drawings means such as a stylus pen or even a finger on a touchscreen, on a field provided on the user device at the time of transmitting each check issuance request with check information.

The payment by the digital check displayed on the user device may be easily conducted by capturing the image of the digital check by the device of the check recipient. For instance, almost all mobile phones used these days have a digital camera or a scanner, such as Zxing. The image of the digital check can be readily captured by the camera or the scanner of the check recipient and stored therein in a suitable format. If a mobile phone with such functionality is not available, the recipient of the check may use a standalone digital camera or scanner to capture the image of the digital check. The digital check can be deposited, to be redeemed, to any financial institution, including the service provider, that accepts a digital check by, for example, a wired transfer of the captured image of the digital check from the check recipient's device to a suitable physical portal located at a financial institution. The image of the digital check can be also deposited to a financial institution by a wireless transmission to an online portal if the financial institution is equipped with such a system. Or, if it is preferred, the recipient may print the image of the digital check and make a deposit of it as is done with ordinary paper checks. The digital check deposited into a financial institution can go through the ordinary clearance procedures performed with paper checks, and once the digital check is cleared, the check amount is drawn from the user's account with the service provider, reducing its balance.

In an embodiment, the digital check may be used at an online payment transaction setting. For example, a user may make an online purchase from a commercial website, using the user device such as a mobile phone or PC. If the entity owning the website accepts a digital check as a payment, the user may request, from the same user device, the service provider to issue a digital check on the user device according to the same process 200 described hereinbefore. In this situation, the user may have to provide the payee's name to the service provider. But the payee's name can be still determined automatically, not manually provided from the user. For example, in one embodiment, the website itself may support the feature of requesting a digital check to the service provider for the user. If the user uses that feature to request a digital check, the name of the payee, most probably the website's owner, will be automatically provided to the service provider. Or in another embodiment, the user application on the user device, used for requesting a digital check issuance, may be coupled with a web browser with which the user is making an online purchase. Then, the user application may automatically pick up the payee's name from the website the user is shopping, and transmit it to the service provider.

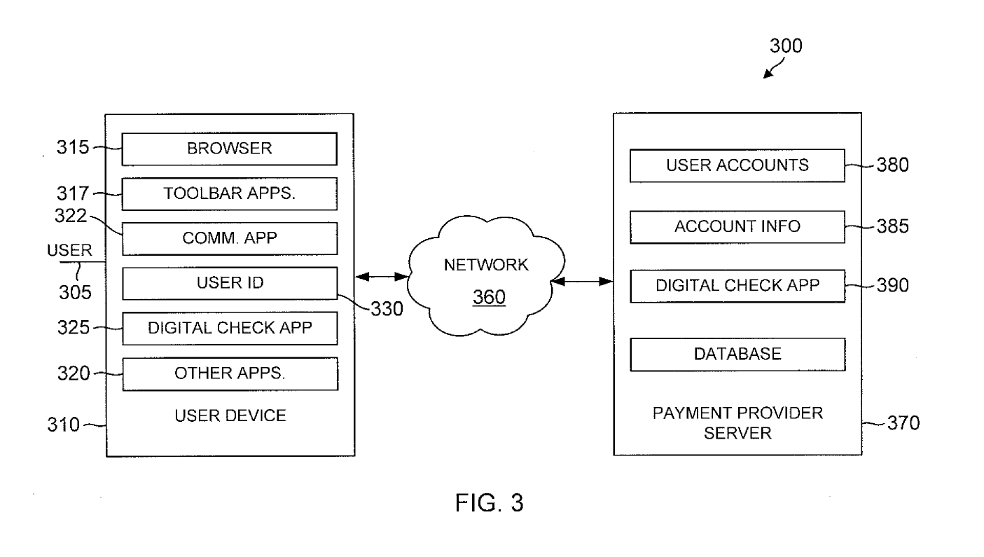

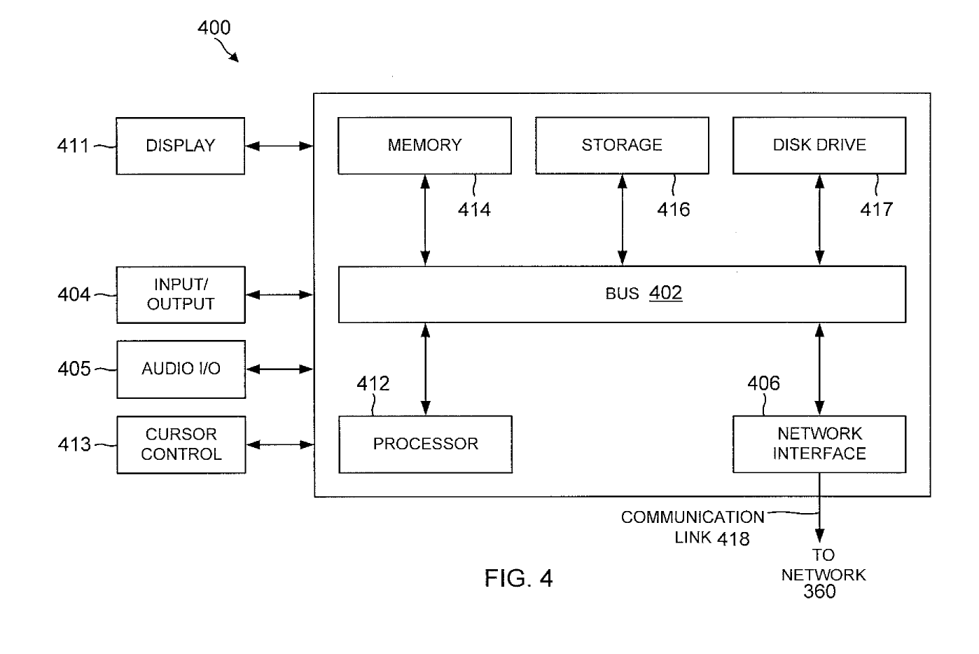

FIG. 3 is a block diagram of a networked system 300 configured to handle a transaction, such as described above, in accordance with an embodiment of the invention. System 300 includes a user device 310 and a service provider server 370 in communication over a network 360. Service provider server 370 may be maintained by a service provider, such as PayPal, Inc. of San Jose, Calif. A user 305 utilizes the user device 310 to request issuance of a digital check to the service provider server 370. Although only one user device is shown, a plurality of user devices may be connected to the service provider server 370 if there are multiple users having accounts with the service provider.

The user device 310 and service provider server 370 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 300, and/or accessible over network 360.

The network 360 may be implemented as a single network or a combination of multiple networks. For example, in various embodiments, network 360 may include the Internet or one or more intranets, landline networks, wireless networks, and/or other appropriate types of networks.

The user device 310 may be implemented using any appropriate hardware and software configured for wired and/or wireless communication over network 360. For example, in one embodiment, the user device 310 may be implemented as a personal computer (PC), a smart phone, personal digital assistant (PDA), laptop computer, tablet, and/or other types of computing devices capable of transmitting and/or receiving data, such as an iPad™ from Apple™.

The user device 310 may include one or more browser applications 315 which may be used, for example, to provide a convenient interface to permit the user 305 to browse information available over network 360. For example, in one embodiment, browser application 315 may be implemented as a web browser configured to view information available over the Internet, and/or access merchant sites for viewing and purchasing commercial products. The user device 310 may also include one or more toolbar applications 317 which may be used, for example, to provide client-side processing for performing desired tasks in response to operations selected by the user 305. In one embodiment, the toolbar application 317 may display a user interface in connection with the browser application 315 as further described herein.

The user device 310 may further include a digital check application 325 by which the user 305 may set up a digital check account(s), determine preferences on digital checks, or transmit a check issuance request, a user identifier, a payee identifier, and a check amount to the service provider server 370 via network 360. The digital check application 325 may be incorporated into the browser 315 in one embodiment.

The user device 310 may further include other applications 320 as may be desired in particular embodiments to provide desired features to user device 310. For example, other applications 320 may include security applications for implementing client-side security features, programmatic client applications for interfacing with appropriate application programming interfaces (APIs) over network 360, or other types of applications. The applications 320 may also include email, texting, voice and IM applications that allow the user 305 to send and receive emails, calls, and texts through network 360, as well as applications that enable the user 305 to communicate, transfer information, and make payments. The user device 310 includes one or more user identifiers 230 which may be implemented, for example, as operating system registry entries, cookies associated with browser application 315, identifiers associated with hardware of the user device 310, or other appropriate identifiers, such as used for payment/user/device authentication. In one embodiment, user identifier 230 may be used by a payment provider to associate the user 305 with a particular account maintained by the service provider as further described herein. A communications application 322, with associated interfaces, enables the user device 310 to communicate within system 300.

The service provider server 370 may be maintained, for example, by an online service provider which may issue a digital check to the user 305. The service provider server 370 also maintains a plurality of user accounts 380, each of which may include account information 385 associated with individual users. For example, the account information 385 may include private financial information of users such as account numbers, passwords, device identifiers, user names, phone numbers, credit card information, bank information, or other financial information, and/or shipping information.

The service provider server 370 includes a digital check application 390 which may be configured to interact with the user device 310 over network 360 to facilitate setting a digital check account and issuance of a digital check and receive information transmitted from the user device 310, such as a digital check issuance request and check information comprising a user identifier, a payee identifier, and a check amount, as described in the processes 100 and 200 in FIGS. 1 and 2.

FIG. 3 is a block diagram of a computer system 300 suitable for implementing one or more embodiments of the present disclosure. In various implementations, the user device may comprise a personal computing device (e.g., smart phone, a computing tablet, a personal computer, laptop, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 300 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a payment provider server via network 360. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many fauns, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

1. A system of a service provider, comprising:
a memory storing account information for a user; and
one or more processors in communication with the memory, the one or more processors being configured to:
maintain a digital check account for the user for issuing digital checks;
generate a digital check based on a payment request of the user; and
format an image of the digital check for display on a user device of the user;
wherein the image of the digital check indicates cheek information comprising a routing number, an account number, an account holder's name, a check amount, a signature of the user, and a payee's name, and wherein the image of the digital check is scannable by a device of the payee.

2. The system of claim 1, wherein the one or more processors are farther configured to:
capture a signature of the user at the user device; and
insert the signature of the user in the image of the digital check.

3. The system of claim 1, wherein the digital check is generated by a user application developed by the service provider and installed on the user device.

4. The system of claim 1, wherein the one or more processors is further configured to receive a digital check issued from the digital check account.

5. The system of claim 4, wherein the one or more processors is further configured to determine whether the digital check account has a sufficient balance to cover the check amount.

6. The system of claim 1, wherein the payee is determined based on a location detected at the user device.

7. The system of claim 1, wherein the one or more processors is further configured to permit the user to set multiple digital check accounts for having digital checks issued therefrom and generated by the user on the user device.

8. A method comprising:
maintaining, by a hardware processor, a digital check account for a user for issuing digital checks;
generating, by the hardware processor, a digital check based on a payment request of the user; and
formatting, by the hardware processor, an image of the digital check for display on a user device of the user;
wherein the image of the digital check indicates check information comprising a routing number, an account number, an account holder's name, a check amount, a signature of the user, and a payee's name, and
wherein the image of the digital check is scannable by a device of the payee.

9. The method of claim 8, further comprising:
capturing a signature of the user at the user device; and
inserting the signature of the user in the image of the digital check.

10. The method of claim 8, wherein the digital check is generated by a user application developed by the service provider and installed on the user device.

11. The method of claim 8, further comprising receiving, by the one or more processors, a digital check issued from the digital check account.

12. The method of claim 11, further comprising determining, by the one or more processors, whether the digital check account has a sufficient balance to cover the check amount.

13. The method of claim 8, further comprising permitting, by the one or more processors, the user to set multiple digital check accounts for having digital checks issued therefrom and generated by the user on the user device.

14. The method of claim 8, wherein the payee is determined based on a location detected at the user device.

15. A system comprising:
a memory storing account information for a user; and
one or more processors in communication with the memory, the one or more processors being configured to:
receive, from a user device, a digital check issuance request, a user identifier, a payee identifier, and a check amount;
determine whether an account associated with the user has a sufficient balance to cover the check amount;
generate a digital check based on the digital check issuance request; and
format an image of the digital check for display on the user device, wherein the digital check indicates check information comprising a routing number, an account number, an account holder's name, the check amount, a signature of the user, and a payee's name, and
wherein the image of the digital check is scannable by a device of the payee.

16. The system of claim 15, wherein the one or more processors are further configured to:
capture a signature of the user at the user device; and
insert the signature of the user in the image of the digital check.

17. The system of claim 15, wherein the one or more processors is further configured to display on the user device tentative check information for receiving a user's confirmation before displaying the digital check.

18. The system of claim 15, wherein the payee identifier is the payee's name.

19. The system of claim 15, wherein the one or more processors is further configured to determine the payee's name from the payee identifier, and wherein the payee identifier is based on a location of the user device.

20. The system of claim 15, wherein the one or more processors is further configured to transmit, at the user's request, the digital check to the payee.
